(19) United States
(12) Patent Application Publication
(10) Pub. No.: US 2012/0050733 A1
(43) Pub. Date: Mar. 1, 2012

(54) LASER MICROSCOPE

(75) Inventor: Shinichi Takimoto, Tokyo (JP)

(73) Assignee: OLYMPUS CORPORATION, Tokyo (JP)

(21) Appl. No.: 13/214,492

(22) Filed: Aug. 22, 2011

Related U.S. Application Data
(63) Continuation of application No. PCT/JP2009/053203, filed on Feb. 23, 2009.

(51) Int. Cl. G01J 3/44; G01N 21/47

(52) U.S. Cl. 356/301; 356/343

(57) ABSTRACT

Provided is a laser microscope, in which laser irradiation optical systems (3, 4, 5, 6) are employed for coaxially irradiating a sample with a CARS laser beam and a Raman scattering laser beam, and CARS light is detected by CARS light detecting means (12) and Raman scattering light is detected by Raman scattering light detecting means (13). In this manner, Raman scattering light observation and CARS light observation can be selectively performed without moving the sample, so that the vibration frequency for the CARS light observation can be efficiently selected without needing complicated work.

### TECHNICAL FIELD

The present invention relates to a laser microscope that is suitably applicable in the field of cell biology, as well as to the inspection technology used in the field of medicine, pharmaceuticals, and semiconductors.

### RELATED ART

In recent years, as a microscope usable in research for functional analysis of biomolecules such as proteins and DNA, there is known a Coherent anti-Stokes Raman scattering microscope (hereinafter, referred to as CARS microscope) capable of three-dimensionally observing such molecules without labeling the molecules with dyes.

The microscope is adapted to measure Coherent anti-Stokes Raman scattering light (hereinafter, also referred to as CARS light as appropriate) generated in Coherent anti-Stokes Raman scattering process (hereinafter, referred to as CARS process), which is one of the third-order non-linear optical process. In the following, with reference to an energy diagram of the CARS process shown in FIG. 14, the generation principle of the CARS light is described.

It is assumed that molecules in a sample to be observed have a vibration mode of frequency ω_{V}, and a first pulse laser beam of frequency ω₁ and a second pulse laser beam of frequency ω₂ are made incident on the sample. When the frequency difference ω₁-ω₂ coincides with the frequency ω_{V} of the sample, a number of molecules in the ground state are resonantly vibrated to be in the excited state. Then, the first pulse laser beam of frequency ω₁ is subjected in part to Doppler modulation of the intrinsic frequency ω_{V} of the molecules, so that CARS light of ω_{AS} is generated. Here, the relation between the above-mentioned frequencies is represented by the following expression.

ω_{As}=ω₁+ω_{V}=2ω₁−ω₂ (1)

In the CARS microscope using the CARS process, samples do not need to be labeled with dyes even when the sample is not fluorescent, and thus the samples are not affected by dyes. Further, as compared to a spontaneous Raman scattering microscope, a signal with higher intensity can be obtained with smaller excitation power.

As described above, the CARS process involves two CARS laser beams which are different in frequency and correspond to a vibration mode having a specific frequency ω_{V}. Accordingly, the intrinsic frequency of the sample needs to be identified prior to the observation of the sample using the CARS microscope. In order to obtain the frequency, the molecular vibrational information of the sample is obtained using a Raman spectrometer.

With reference to the energy diagram of the Raman scattering process shown in FIG. 15, a method of obtaining the molecular frequency is described. When the sample is irradiated with a Raman scattering laser beam of frequency coₒ, energy exchanges occur between the molecules forming the sample and the Raman scattering laser beam, which produces Raman scattering light having a frequency component of ω₀-ω_{V}. Accordingly, the molecular frequency can be obtained based on the frequency difference between the incident light and the scattered light.

In general, a sample contains a number of molecules, and each molecule has a plurality of vibration modes. Therefore, the Raman scattering light is measured as a Raman spectrum, which is obtained by detecting, using a spectrometer or an interferometer, the Raman scattering light generated from a laser of a single wavelength irradiated onto the sample. FIG. 16 illustrates an example of the Raman scattering spectrum. In the spectrum, the frequency at which the Raman scattering light reaches its peak in intensity is considered to reflect the frequency information of the sample molecules. In the CARS light analysis, a molecular frequency ω_{V} to be measured is determined from among the frequencies each having a peak of the Raman scattering light intensity.

There have already been some development examples of the CARS microscope based on the above-mentioned principle. For example, there is known a CARS microscope in which two CARS laser beams having different wavelengths are coaxially focused through a microscope objective onto a sample so as to scan the sample, to thereby minimize a spot size of a focal point on the sample and improve the spatial resolution (see, for example, JP 2002-520612 A).

There is also known a technology in which light emitted from a single laser source is divided into two, so that one of the split light is subjected to wavelength conversion at an optical parametric amplifier and superposed on the other divided laser light which is not subjected to wavelength conversion, to thereby form a single CARS laser beam (see, for example, JP 2002-107301 A). There is also known a CARS microscope in which a microstructured optical element spectrally broadens a pulse laser beam of single wavelength, and two light beams having wavelengths that are selected out of the spectrally-broadened light are employed as a CARS laser beam (see, for example, U.S. Pat. No. 7,092,086).

As described above, in the CARS microscope, laser beams of two wavelengths are coaxially superposed on each other, and focused on the sample through a microscope objective.

### DISCLOSURE OF THE INVENTION

### Problems to be Solved by the Invention

However, as described above, in order to observe a sample using the CARS microscope, the molecular vibrational information of the sample needs to be identified in advance. For this purpose, in the conventional CARS microscopy, a Raman spectrometer is separately used for observing the Raman scattering light in order to obtain the molecular vibrational information of the sample. In this method, different devices are used for observing the Raman scattering light to obtain the molecular information and for observing CARS light, and hence the sample needs to be transferred from one device to the other. As a result, it is extremely difficult to obtain the molecular vibrational information and observe the CARS light on the same observation point on one sample, which makes it difficult to efficiently select the frequencies at which CARS light of high intensity can be obtained according to the observation point on the sample. If the frequencies are not appropriately selected, CARS light of high intensity cannot be measured, with the result that a microscopic image having a sufficient contrast cannot be obtained. As a result, there arises a need to observe again the Raman scattering light so as to obtain the vibrational information, which makes the work complicated and inefficient.

Accordingly, the present invention has been made in view of the above-mentioned problems, and hence it is an object of the invention to provide a laser microscope capable of detecting the Raman scattering light and observing the CARS light selectively without moving the sample to be observed, so that vibration frequencies for CARS light observation can be efficiently selected without involving complicated work.

### Means for Solving the Problem

In order to attain the above-mentioned object, a laser microscope according to a first aspect of the present invention includes:

a laser irradiation optical system capable of coaxially irradiating a sample with a CARS laser beam and a Raman scattering laser beam;

CARS light detecting means for detecting CARS light generated from the sample irradiated with the CARS laser beam; and

Raman scattering light detecting means for detecting Raman scattering light generated from the sample irradiated with the Raman scattering laser beam.

According to a second aspect of the present invention, in the laser microscope according to the first aspect, the CARS light detecting means and the Raman scattering light detecting means are disposed on a transmission side of incident light from the laser irradiation optical system, with respect to the sample.

According to a third aspect of the present invention, the laser microscope according to the second aspect further includes a dichroic mirror for separating the CARS light and the Raman scattering light from each other and guiding the CARS light to the CARS light detecting means while guiding the Raman scattering light to the Raman scattering light detecting means, the dichroic mirror being disposed on the transmission side of the sample.

According to a fourth aspect of the present invention, in the laser microscope according to the first aspect,

the CARS light detecting means is disposed on a reflection side of incident light from the laser irradiation optical system, with respect to the sample, and

the Raman scattering light detecting means is disposed on a transmission side of the incident light from the laser irradiation optical system, with respect to the sample.

According to a fifth aspect of the present invention, the laser microscope according to the fourth aspect further includes a dichroic mirror for separating the CARS laser beam and the Raman scattering laser beam from the CARS light and guiding the CARS laser beam and the Raman scattering laser beam to the sample while guiding the CARS light to the CARS light detecting means.

According to a sixth aspect of the present invention, in the laser microscope according to the first aspect,

the CARS light detecting means is disposed on a transmission side of incident light from the laser irradiation optical system, with respect to the sample, and

the Raman scattering light detecting means is disposed on a refection side of the incident light from the laser irradiation optical system, with respect to the sample.

According to a seventh aspect of the present invention, the laser microscope according to the sixth aspect further includes a dichroic mirror for separating the CARS laser beam and the Raman scattering laser beam from the Raman scattering light and guiding the CARS laser beam and the Raman scattering laser beam to the sample while guiding the Raman scattering light to the Raman scattering light detecting means, the dichroic mirror being arranged on the reflection side of the sample.

According to an eighth aspect of the present invention, in the laser microscope according to the first aspect, the CARS light detecting means and the Raman scattering light detecting means are disposed on a reflection side of incident light from the laser irradiation optical system, with respect to the sample.

According to a ninth aspect of the present invention, the laser microscope according to the eighth aspect further includes a dichroic mirror for separating the CARS light and the Raman scattering light from each other and guiding the CARS light to the CARS light detecting means while guiding the Raman scattering light to the Raman scattering light detecting means, the dichroic mirror being arranged on the reflection side of the sample.

According to a tenth aspect of the present invention, in the laser microscope according to any one of the first to ninth aspects, the CARS light detecting means has a band-pass filter for extracting only the CARS light.

According to an eleventh aspect of the present invention, in the laser microscope according to any one of the first to tenth aspects, the Raman scattering light detecting means has a band-pass filter for extracting only the Raman scattering light.

According to a twelfth aspect of the present invention, in the laser microscope according to any one of the first to eleventh aspects, the Raman scattering light detecting means has a spectrometer for detecting a spectrum of the Raman scattering light.

According to a thirteenth aspect of the present invention, the laser microscope according to any one of the first to twelfth aspects further includes:

switching means for switching between the CARS laser beam and the Raman scattering laser beam entering the laser irradiation optical system; and

control means for controlling the switching operation performed by the switching means.

### Effect of the Invention

According to the present invention, laser irradiation optical systems are employed for coaxially irradiating a sample with the CARS laser beam and the Raman scattering laser beam, so that the CARS light is detected by the CARS light detecting means while the Raman scattering light is detected by the Raman scattering light detecting means. Therefore, the Raman scattering light observation and the CARS light observation can be selectively performed without moving the sample, so that the vibration frequency for the CARS light observation can be efficiently selected without needing complicated work.

### BRIEF DESCRIPTION OF THE DRAWINGS

FIG. 1 is a schematic structural diagram illustrating a laser microscope according to the first embodiment of the present invention;

FIG. 2 is a schematic configuration diagram of a CARS laser beam source portion of FIG. 1;

FIG. 3 is a schematic configuration diagram of a Raman scattering laser beam source portion of FIG. 1;

FIGS. 4(a) to 4(c) are schematic diagrams for illustrating the wavelength characteristics of a dichroic mirror and band-pass filters of FIG. 1, respectively;

FIG. 5 is a schematic configuration diagram of a laser microscope according to a second embodiment of the present invention;

FIG. 6 is a schematic diagram for illustrating the wavelength characteristics of a dichroic mirror of FIG. 5;

FIG. 7 is a schematic configuration diagram illustrating a laser microscope according to a third embodiment of the present invention;

FIG. 8 is a schematic configuration diagram illustrating a laser microscope according to a fourth embodiment of the present invention;

FIG. 9 is a schematic diagram for illustrating the wavelength characteristics of a dichroic mirror of FIG. 8;

FIG. 10 is a schematic diagram for illustrating the Raman scattering light and the CARS light overlapping each other, according to the fifth embodiment of the present invention;

FIGS. 11(a) and 11(b) are schematic diagrams for illustrating the wavelength characteristics of band-pass filters used in the fifth embodiment of the present invention;

FIG. 12 is a schematic configuration diagram illustrating a laser microscope according to the fifth embodiment of the present invention;

FIG. 13 is a time chart illustrating a switching operation of laser switching means, a detector, and a spectrometer of FIG. 12;

FIG. 14 is an energy diagram of a CARS process;

FIG. 15 is an energy diagram of a Raman scattering process; and

FIG. 16 is a graph showing an example of a Raman scattering spectrum.

### DESCRIPTION OF SYMBOLS

1 CARS laser beam source portion
1a first pulse laser source
1b second pulse laser source
1c half-silvered mirror
1d mirror
2 Raman scattering laser beam source portion
2a Raman scattering laser source
3 half-silvered mirror
4 mirror
5 galvano-scanner
5a mirror
5b mirror
6 lens
7 sample surface
8 focal position
9 mirror
10 lens
11 dichroic mirror
12 CARS light detecting means
13 Raman scattering light detecting means
14 band-pass filter
15 detector
16 band-pass filter
17 spectrometer
18 dichroic mirror
19 dichroic mirror
20 laser switching means
21 laser switching means
22 control means

### BEST MODES FOR CARRYING OUT THE INVENTION

In the following, embodiments of the present invention are described with reference to the accompanying drawings.

### First Embodiment

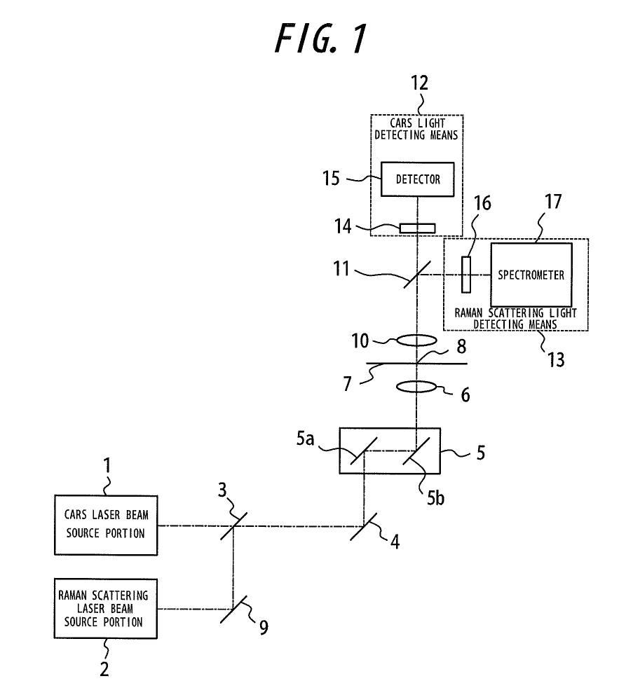

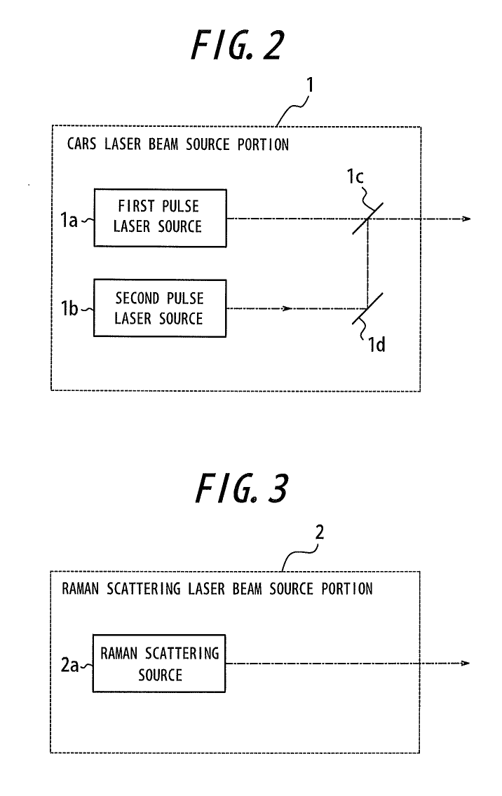

FIG. 1 is a view illustrating a schematic configuration of a laser microscope according to a first embodiment of the present invention. The laser microscope includes a CARS laser beam source portion 1 and a Raman scattering laser beam source portion 2. As illustrated in FIG. 2, the CARS laser beam source portion 1 has a first pulse laser source 1a and a second pulse laser source 1b, which are different from each other in wavelength. A laser beam from the first pulse laser source passes through the half-silvered mirror 1c to be emitted therefrom, while a laser beam from the second pulse laser source is reflected by the reflection mirror mirror 1d and then reflected by the half-silvered mirror 1c, so as to be coaxially synthesized with the laser beam from the first pulse laser source and emitted therefrom. In this manner, a CARS laser beam having two wavelengths are emitted from the CARS laser beam source portion 1. In this embodiment, the first pulse laser source 1a employs a fixed-wavelength laser, while the second pulse laser source 1b employs a laser such as a titanium sapphire laser, which is adjustable in wavelength according to the molecule frequency ω_{V} of a sample.

Further, the Raman scattering laser beam source portion 2 is configured by including, as illustrated in FIG. 3, the Raman scattering laser source 2a for emitting a continuous-wave (CW) laser beam of a single wavelength, so as to be adapted to emit a Raman scattering laser beam.

In FIG. 1, the CARS laser beam emitted from the CARS laser beam source portion 1 is adapted to pass through the half-silvered mirror 3 to be reflected by a reflection mirror 4, and then further to pass through a galvano-scanner 5 having mirrors 5a, 5b for two-dimensional scanning so as to be focused by a lens 6 onto a focus position on a sample surface 7. In particular, when the mirrors 5a, 5b have a deflection angle of 0, the focus position coincides with the focal position 8 of the lens 6.

Further, the Raman scattering laser beam emitted from the Raman scattering laser beam source portion 2 is adapted to be reflected by the half-silvered mirror 3 after being reflected by a reflection mirror 9 so as to be coaxially synthesized with the CARS laser beam, that is, the center light beam of the Raman scattering laser beam is made coincide with the center light beam of the CARS laser beam, so that the Raman scattering laser beam is focused by the lens 6 onto the focus position on the sample surface after passing through the reflection mirror 4 and the galvano-scanner 5. Accordingly, in this embodiment, a laser illumination optical system is configured by including the half-silvered mirror 3, the reflection mirror 4, the galvano-scanner 5, and the lens 6.

In this embodiment, the CARS light and the Raman scattering light are each detected in a through-transmission mode. For this purpose, a lens 10, a dichroic mirror 11 for separating the CARS light and the Raman scattering light from each other, CARS light detecting means 12, and Raman scattering light detecting means 13 are disposed on the transmission side of incident light with respect to the sample, so that the CARS light generated from the focus position on the sample surface 7 passes through the lens 10 and is separated by the dichroic mirror 11 so as to be guided to the CARS light detecting means 12 while the Raman scattering light generated from the focus position on the sample surface 7 passes through the lens 10 and is separated by the dichroic mirror 11 so as to be guided to the Raman scattering light detecting means 13.

Here, the CARS light detecting means 12 has a band-pass filter 14 and a detector 15, so that the CARS separated by the dichroic mirror 11 can be detected by the detector 15 via the band-pass filter 14. Further, the Raman scattering light detecting means 13 has a band-pass filter 16 and a spectrometer 17, so that the Raman scattering light separated by the dichroic mirror 11 can be detected by the spectrometer 17 via the band-pass filter 16.

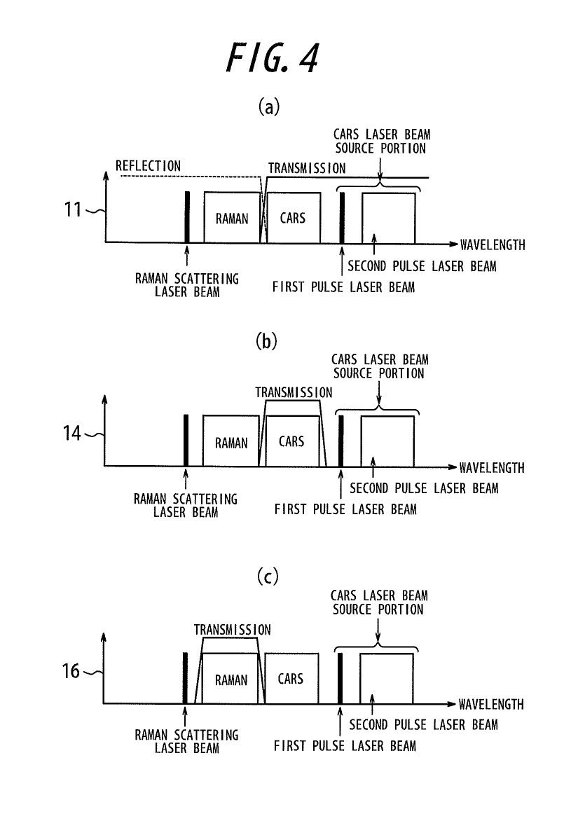

In the following, the wavelength characteristics of the dichroic mirror 11, the band-pass filter 14, and the band-pass filter 16 are described with reference to FIGS. 4(a) and 4(b).

The Raman scattering laser beam is a single-color laser beam that has a shortest wavelength among the laser beams emitted from the scattering excitation laser sources 1a, 1b, 2a. This Raman scattering laser beam is irradiated on the sample to obtain Raman scattering light. In this embodiment, Stokes light in the Raman scattering light is subjected to observation, which appears on the longer wavelength side than the wavelength of the Raman scattering laser beam and has a spectrum distribution that expands based on the frequency of the sample.

On the other hand, in this embodiment, the first pulse laser source 1a of the CARS laser beam source portion 1 employs a fixed-wavelength laser source while the second pulse laser source 1b employs a variable-wavelength laser source so as to be adjustable in wavelength according to the frequency ω_{V} to be observed, as described above. Further, the wavelength of the first pulse laser source 1a, the wavelength of the second pulse laser source 1b, and the wavelength of the CARS light satisfy the above-mentioned expression (1), and the CARS light appears on the shorter wavelength side than the wavelength of the first pulse laser source 1a.

Therefore, as illustrated in FIG. 4(a), the dichroic mirror 11 is configured to have wavelength characteristics of transmitting the CARS light and the CARS laser beam while reflecting the Raman scattering light and the Raman scattering laser beam. Meanwhile, as illustrated in FIG. 4(b), the band-pass filter 14 is configured to have wavelength characteristics of transmitting only the CARS light, and, as illustrated in FIG. 4(c), the band-pass filter 16 is configured to have wavelength characteristics of transmitting only the Raman scattering light to pass therethrough.

Next, the CARS microscopy that employs a laser microscope according to this embodiment is described. First, prior to the observation of the CARS light of a sample, the Raman spectrum is detected in order to obtain the molecular vibrational information of the sample. In the detection of the Raman spectrum, the sample is set onto a sample stage of the laser microscope, and then the Raman scattering laser beam source portion 2 is actuated to emit the Raman scattering laser beam, so that the Raman scattering laser beam is focused by the lens 6 onto the focus position on the sample surface 7 via the reflection mirror 9, the half-silvered mirror 3, the reflection mirror 4, and the galvano-scanner 5. It should be noted that the galvano-scanner 5 does not perform scanning in the above-mentioned detection of the Raman spectrum.

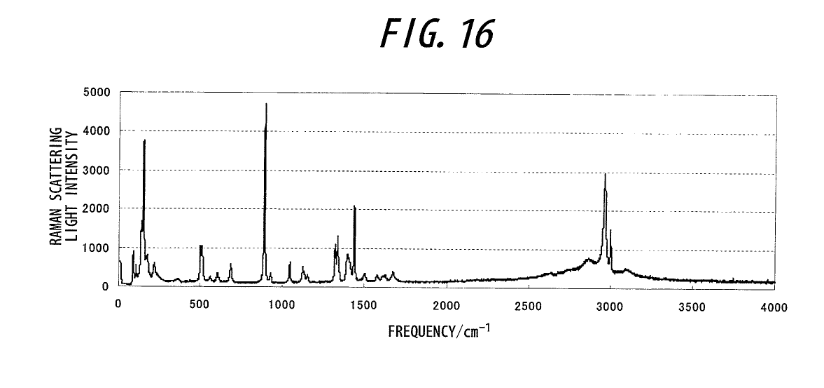

The sample is irradiated with the Raman scattering laser beam so that Raman scattering light is scattered from the sample. The Raman scattering light then passes through the lens 10 and the dichroic mirror 11 to enter the band-pass filter 16, where noise components including the Raman scattering laser beam that has passed through the sample are removed, so that only the Raman scattering light component enters the spectrometer 17, to thereby detect a Raman spectrum illustrated in FIG. 16.

After the Raman spectrum is detected as described above, the molecule frequency ω_{V} corresponding to the molecular vibration mode of the sample is selected from the Raman spectrum, and the CARS light of the sample is observed. In the observation of the CARS light, the actuation of the Raman scattering laser beam source portion 2 is stopped, without moving the sample from the state of detecting the Raman spectrum, and the CARS laser beam source portion 1 is actuated to emit the CARS laser beam.

The CARS laser beam passes through the half-silvered mirror 3, the reflection mirror 4, and the galvano-scanner 5, so as to be focused by the lens 6 onto the sample surface 7, and the galvano-scanner 5 two-dimensionally scans the focus position on the sample surface 7.

The sample is irradiated with the CARS laser beam so that the CARS light is scattered from the sample. The CARS light then passes through the lens 10 and the dichroic mirror 11 to enter the band-pass filter 14, where noise components including the CARS laser beam that has passed through the sample are removed, so that only the CARS light component enters the detector 15 for detection.

Here, the CARS microscope according to this embodiment includes a computer (not shown) for subjecting a signal of the CARS light obtained in the detector 15 to arithmetic processing so as to form an image. The galvano-scanner 5 scans the sample surface 7 along with pulse oscillations by the CARS laser beam source portion 1, and the focus positions corresponding to the pulse oscillations are defined as pixels which are subjected to arithmetic processing on the computer, to thereby form a two-dimensional image of the sample. Further, the focus positions of the CARS laser beam with respect to the sample are displaced in the optical axis direction, so as to obtain plane images at different depths, to thereby form a three-dimensional microscopic image.

As described above, in this embodiment, the CARS laser beam and the Raman scattering laser beam enter the sample through coaxial optical paths, so that the CARS microscopy observation and the Raman scattering light observation can be selectively performed on the same device without moving the sample. Therefore, the frequency ω_{V} can be efficiently selected from the molecular vibration observed through the Raman scattering obtained at a position in the sample which is to be subjected to the CARS microscopy observation, so as to perform the CARS light observation. Further, in this embodiment, the CARS light is detected in the through-transmission mode, and hence, particularly when the molecules (molecular group) in the sample are larger than the wavelength order of the CARS laser beam, the CARS light is intensely radiated only in the forward direction with respect to the irradiation direction of the laser beam due to the interference effect of the CARS light itself, so that the CARS light can be observed effectively.

### Second Embodiment

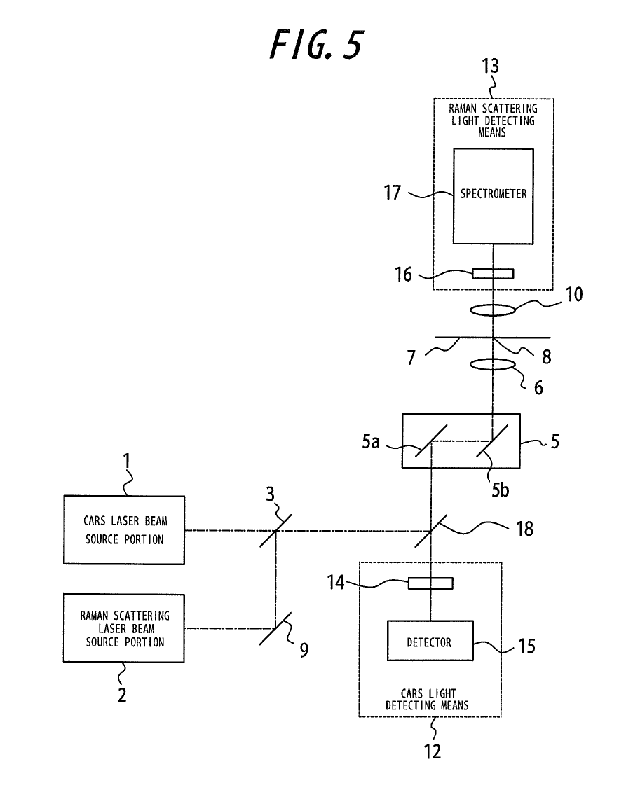

FIG. 5 is a view illustrating a schematic configuration of a laser microscope according to a second embodiment of the present invention. This embodiment is different from the first embodiment in that the CARS light detecting means 12 is disposed on the reflection side so that the CARS light is detected in the epi-illumination mode.

Accordingly, in this embodiment, the dichroic mirror 11 of the first embodiment is eliminated, and a dichroic mirror 18 is disposed in place of the reflection mirror 4, so that light scattered from the focus position on the sample surface 7 in the reflection direction is adapted to pass through the lens 6, the galvano-scanner 5, and the dichroic mirror 18, so as to enter the CARS light detecting means 12. Further, light scattered from the focus position on the sample surface 7 in the transmission direction is adapted to pass through the lens 10 so as to enter the Raman scattering light detecting means 13.

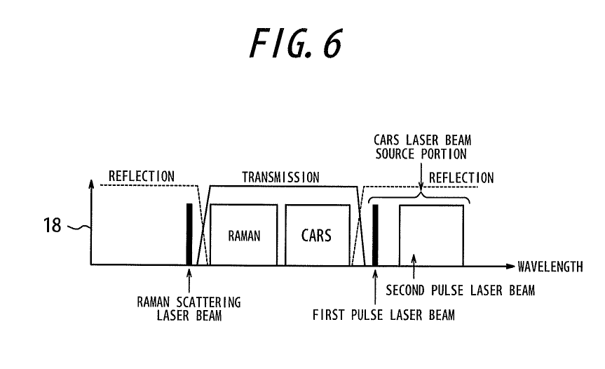

Here, the band-pass filters 14, 16 have wavelength characteristics same as that of the band-pass filters of the first embodiment. Further, as illustrated in FIG. 6, the dichroic mirror 18 is configured to have wavelength characteristics of transmitting at least the CARS light while reflecting the CARS laser beam and the Raman scattering laser beam. The rest of the configuration is similar to that of the first embodiment, and hence the same constituent elements are denoted by the same reference symbols and the description thereof is omitted.

In the CARS microscopy using the laser microscope according to this embodiment, the sample is irradiated with the Raman scattering laser beam similarly to the first embodiment, except that the reflection mirror 4 is replaced by the dichroic mirror 18. Further, the Raman scattering light can be detected through the similar operation as in the first embodiment, except that the dichroic mirror 11 does not present on the optical path of the scattered light, so as to obtain a Raman spectrum.

Further, the CARS laser beam follows the same optical path as in the first embodiment, except that the reflection mirror 4 is replaced by the dichroic mirror 18, so as to be focused on the sample surface 7 by the lens 6. Further, similarly to the first embodiment, the galvano-scanner 5 two-dimensionally scans the focus position on the sample surface 7.

The sample is irradiated with the CARS laser beam so that CARS light is scattered from the sample in the reflection direction. The CARS light then passes through the lens 6 and the galvano-scanner 5 so as to enter the dichroic mirror 18, where the CARS laser beam reflected by the sample surface 7 is separated. Further, light that has passed through the dichroic mirror 18 enters the band-pass filter 14 of the CARS light detecting means 12 and noise components of the light are removed in the band-pass filter 14, so that only the CARS light component enters the detector 15 for detection.

Even in this embodiment, a computer (not shown) can be used to obtain a two dimensional CARS microscopic image and a three-dimensional CARS microscopic image of the sample by the similar method as in the first embodiment.

As described above, in this embodiment, similarly to the first embodiment, the CARS laser beam and the Raman scattering laser beam enter the sample through coaxial optical paths, so that the CARS microscopy observation and the Raman scattering light observation can be selectively performed on the same device without moving the sample. Therefore, the frequency ω_{V} can be efficiently selected from the molecular vibration observed through the Raman scattering obtained at a position in the sample which is to be subjected to the CARS microscopy observation, so as to perform the CARS light observation. Further, in this embodiment, the CARS light is detected in the epi-illumination mode, and hence, particularly when the molecules (molecular group) in the sample are smaller than the wavelength order of the CARS laser beam, the CARS light can be observed effectively, as compared to the CARS light detecting means of through-transmission mode in which larger noise components (nonresonance background) are generated together with the CARS light, ahead of the sample. Further, this embodiment is also effective when performing CARS observation of a sample (such as a tissue of a living body) that has molecules (molecular group) larger than the order of the CARS light excitation wavelength and low in wavelength transmittance.

### Third Embodiment

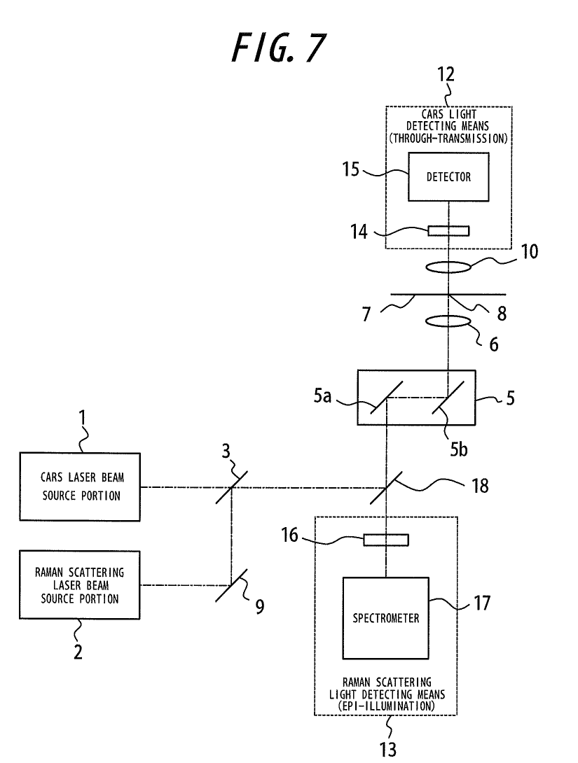

FIG. 7 is a view illustrating a schematic configuration of a laser microscope according to a third embodiment of the present invention. This embodiment is different from the first embodiment in that the Raman scattering light detecting means 13 is disposed on the reflection side so as to detect the Raman scattering light in the epi-illumination mode.

Accordingly, in this embodiment, the dichroic mirror 11 of the first embodiment is eliminated, and the dichroic mirror 18 is disposed in place of the reflection mirror 4, so that light scattered from the focus position on the sample surface 7 in the transmission direction is adapted to pass through the lens 10 so as to enter the CARS light detecting means 12. Further, light scattered from the focus position on the sample surface 7 in the reflection direction is adapted to pass through the lens 6, the galvano-scanner 5, and the dichroic mirror 18, so as to enter the Raman scattering light detecting means 13.

Here, the band-pass filters 14, 16 have wavelength characteristics same as those of the band-pass filters of the first embodiment. Further, as illustrated in FIG. 6, the dichroic mirror 18 is configured to have wavelength characteristics of transmitting the Raman scattering light while reflecting the CARS laser beam and the Raman scattering laser beam. The rest of the configuration is similar to that of the first embodiment, and hence the same constituent elements are denoted by the same reference symbols and the description thereof is omitted.

In the CARS microscopy using the laser microscope according to this embodiment, the sample is irradiated with the Raman scattering laser beam similarly to the first embodiment, except that the reflection mirror 4 is replaced by the dichroic mirror 18. Further, the Raman scattering light scattered from the sample upon irradiation of the Raman scattering laser beam passes through the lens 6 and the galvano-scanner 5 so as to enter the dichroic mirror 18, where the Raman scattering laser beam reflected by the sample surface 7 is separated. Further, light that has passed through the dichroic mirror 18 enters the band-pass filter 16 of the Raman scattering light detecting means 13 and noise components of the light are removed in the band-pass filter 16, so that only the Raman scattering light component enters the spectrometer 15 for detection.

Further, the CARS laser beam follows the same optical path as in the first embodiment, except that the reflection mirror 4 is replaced by the dichroic mirror 18, so as to be focused on the sample surface 7 by the lens 6. Further, similarly to the first embodiment, the galvano-scanner 5 two-dimensionally scans the focus position on the sample surface 7. Further, CARS light can be detected through the similar operation as in the first embodiment, except in that the dichroic mirror 11 does not present on the optical path of the scattered light.

Even in this embodiment, a computer (not shown) can be used to obtain a two dimensional CARS microscopic image and a three-dimensional CARS microscopic image of the sample by the similar method as in the first embodiment.

Further, in this embodiment, as described later, the optical axis of the Raman scattering light entering the spectrometer 17 for observing the Raman scattering is not shifted, and hence the Raman scattering light observation and the CARS microscopy observation can be performed simultaneously. In this case, the CARS laser beam source portion 1 and the Raman scattering laser portion 2 are actuated simultaneously, so as to emit the CARS laser beam and the Raman scattering laser at a time. These laser beams follow the same optical path as in the above-mentioned case where the laser beams are separately emitted, and coaxially focused and irradiated onto the focus position on the sample surface 7 at a time.

In this case, the scattered light scattering on the reflection side of the sample surface 7 passes through the lens 6 and the galvano-scanner 5 so as to enter the dichroic mirror 18. In the dichroic mirror, the CARS laser beam and Raman scattering laser beam reflected by the sample surface are separated, so as to allow only the CARS light and the Raman scattering light to pass therethrough. Further, the light that has passed through the dichroic mirror 18 enters the band-pass filter 16, in which noise components including the CARS light is removed, so as to allow only the Raman scattering light to enter the spectrometer 17 for detection, to thereby obtain a Raman spectrum.

At this time, this embodiment employs a device configuration in which the spectrometer 17 is disposed on the back side of the galvano-scanner 5 with respect to the sample surface 7 so as to perform the Raman scattering light detection in the epi-illumination mode, and hence, even when the galvano-scanner 5 scans the sample surface 7 with the Raman scattering laser beam, the spectrometer 17 can still be placed in a position (descan position) capable of stabilizing the optical axis of the Raman scattering light entering the spectrometer 17. Therefore, the spectral characteristics of the spectrometer 17 suffers no deterioration resulting from the shift of the optical axis.

On the other hand, scattered light scattering on the transmission side of the sample surface 7 passes through the lens 10 to enter the band-pass filter 14, where noise components including the CARS laser beam, the Raman scattering laser beam, and the Raman scattering light are removed, so that only the CARS light enters the detector 15 for detection. The CARS light thus obtained is processed, to thereby obtain the above-mentioned Raman spectrum as well as an observed CARS microscopic image.

As described above, in this embodiment, similarly to the first and second embodiments, the CARS laser beam and the Raman scattering laser beam enter the sample through coaxial optical paths, so that the CARS microscopy observation and the Raman scattering light observation can be selectively performed on the same device without moving the sample. Therefore, similarly to the first and second embodiments, the frequency ω_{V} can be efficiently selected from the molecular vibration observed through the Raman scattering obtained at a position in the sample which is to be subjected to the CARS microscopy observation, so as to perform the CARS light observation. Further, in this embodiment, the CARS light is detected in the through-transmission mode, and hence, particularly when the molecules (molecular group) in the sample are larger than the wavelength order of the CARS laser beam, the CARS light can be observed effectively as described in the first embodiment. Further, the spectrum of the Raman scattering light can be detected while scanning the sample with the CARS laser beam, so that this embodiment can be promptly adapted to changes in the molecular vibration frequency of the sample during the CARS observation.

### Fourth Embodiment

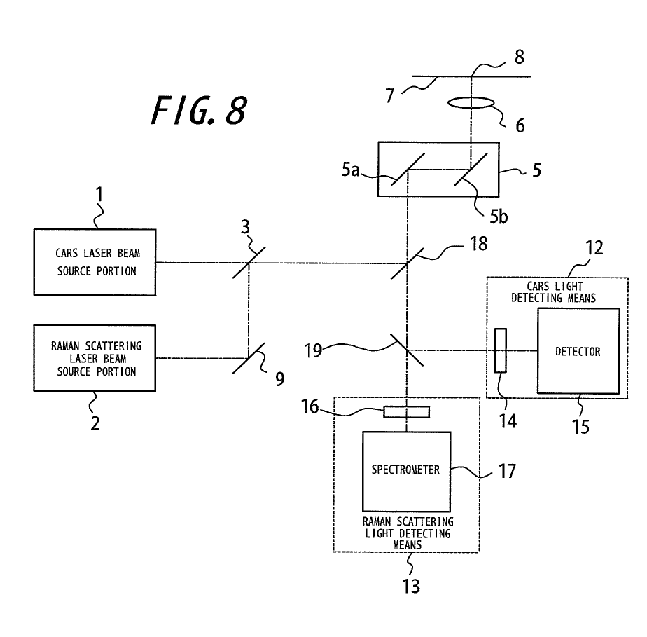

FIG. 8 is a view illustrating a schematic configuration of a laser microscope according to a fourth embodiment of the present invention. This embodiment is different from the first embodiment in that the CARS light detecting means 12 and the Raman scattering light detecting means 13 are disposed on the reflection side so as to detect the CARS light and the Raman scattering light in the epi-illumination mode.

Accordingly, in this embodiment, the dichroic mirror 11 and the lens 10 of the first embodiment are eliminated, and the dichroic mirror 18 is disposed in place of the reflection mirror 4, so that light scattered from the focus position on the sample surface 7 in the reflection direction is adapted to pass through the lens 6, the galvano-scanner 5, and the dichroic mirror 18, so as to enter the dichroic mirror 19. In the dichroic mirror 19, the CARS light component and the Raman scattering light component are separated from each other, so that the CARS light component is adapted to enter the CARS light detecting means 12 while the Raman scattering light component is adapted to enter the Raman scattering light detecting means 13.

Further, the CARS light detecting means 12 is configured such that the CARS light component entering the CARS light detecting means 12 passes through the band-pass filter 14 so as to enter the detector 15, and the Raman scattering light detecting means 13 is configured such that the Raman scattering light component passes through the band-pass filter 16 so as to enter the spectrometer 17.

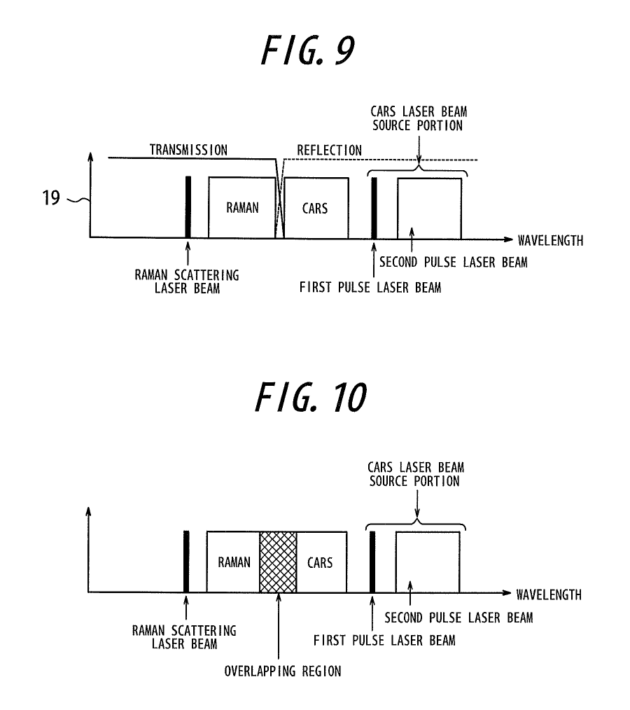

Here, the band-pass filters 14, 16 have wavelength characteristics same as those of the band-pass filters of the first embodiment. Further, as illustrated in FIG. 6, the dichroic mirror 18 is configured to have wavelength characteristics of transmitting the CARS light and the Raman scattering light while reflecting the CARS laser beam and the Raman scattering laser beam. Further, as illustrated in FIG. 9, the dichroic mirror 19 is configured to have wavelength characteristics of reflecting the CARS light and the CARS laser beam while allowing the Raman scattering light and the Raman scattering laser beam. The rest of the configuration is similar to that of the first embodiment, and hence the same constituent elements are denoted by the same reference symbols and the description thereof is omitted.

In the CARS microscopy using the laser microscope according to this embodiment, the sample is irradiated with the Raman scattering laser beam similarly to the first embodiment, except that the reflection mirror 4 is replaced by the dichroic mirror 18. Further, the Raman scattering light scattered from the sample upon irradiation of the Raman scattering laser beam passes through the lens 6 and the galvano-scanner 5 so as to enter the dichroic mirror 18, where the Raman scattering laser beam reflected by the sample surface 7 is separated. Further, light that has passed through the dichroic mirror 18 passes through the dichroic mirror 19 to enter the band-pass filter 16 of the Raman scattering light detecting means 13, and noise components of the light are removed in the band-pass filter 16, so that only the Raman scattering light component enters the spectrometer 17 for detection.

Further, the CARS laser beam follows the same optical path as in the first embodiment, except that the reflection mirror 4 is replaced by the dichroic mirror 18, so as to be focused on the sample surface 7 by the lens 6. Further, similarly to the first embodiment, the galvano-scanner 5 two-dimensionally scans the focus position on the sample surface 7.

The CARS light scattered from the sample in the reflection direction upon irradiation of the CARS laser beam passes through the lens 6 and the galvano-scanner 5 so as to enter the dichroic mirror 18, where the CARS laser beam reflected by the sample surface 7 is separated. Further, light that has passed through the dichroic mirror 18 passes through the dichroic mirror 19 so as to enter the band-pass filter 14 of the CARS light detecting means 12, and noise components of the light are removed in the band-pass filter 14, so that only the CARS light component enters the detector 15 for detection.

Even in this embodiment, a computer (not shown) can be used to obtain a two dimensional CARS microscopic image and a three-dimensional CARS microscopic image of the sample by the similar method as in the first embodiment.

Further, in this embodiment, similarly to the third embodiment, the Raman scattering light observation and the CARS microscopy observation can be performed simultaneously. In this case, similarly to the third embodiment, the CARS laser beam source portion 1 and the Raman scattering laser beam source portion 2 are actuated simultaneously, so that these laser beams are coaxially focused and irradiated onto the focus position on the sample surface at a time.

The scattered light scattering on the reflection side of the sample surface 7 passes through the lens 6 and the galvano-scanner 5 so as to enter the dichroic mirror 18, where the CARS laser beam and the Raman scattering laser beam reflected by the sample surface 7 are separated, so as to allow only the CARS light and the Raman scattering light to pass therethrough. The light that has passed through the dichroic mirror 18 enters the dichroic mirror 19 and is separated into the CARS light component and the Raman scattering light component. Further, this CARS light component enters the band-pass filter 14 for removal of noise components, and then enters the detector 15 for detection. Further, the Raman scattering light component enters the band-pass filter 16 for removal of noise components including the CARS light, so that only the Raman scattering light component enters the spectrometer 17 for detection, to thereby obtain a Raman spectrum.

In this manner, similarly to the third embodiment, this embodiment also has a configuration in which the spectrometer 17 is disposed on the back side of the galvano-scanner 5 with respect to the sample surface 7, so that the CARS microscopy observation and the Raman spectrum observation can be performed simultaneously through the detection of the CARS light, without causing deterioration in the spectral characteristics of the spectrometer 17 resulting from the shift of the optical axis.

As described above, in this embodiment, similarly to the first, second, and third embodiments, the CARS laser beam and the Raman scattering laser beam enter the sample through coaxial optical paths, so that the CARS microscopy observation and the Raman scattering light observation can be selectively performed on the same device without moving the sample. Therefore, similarly to the first and second embodiments, the frequency ω_{V} can be efficiently selected from the molecular vibration observed through the Raman scattering obtained at a position in the sample which is to be subjected to the CARS microscopy observation, so as to perform the CARS light observation. Further, in this embodiment, the CARS light is detected in the epi-illumination mode, and hence, particularly when the molecules (molecular group) in the sample are smaller than the wavelength order of the CARS laser beam, the CARS light can be observed effectively, as compared to the CARS light detecting means of through-transmission mode, similarly to the second embodiment. Further, this embodiment is also effective when performing CARS observation of a sample (such as a tissue of a living body) that has molecules (molecular group) larger than the order of the CARS light excitation wavelength and low in wavelength transmittance. Further, the spectrum of the Raman scattering light can be detected while scanning the sample with the CARS laser beam, so that this embodiment can be promptly adapted to changes in the molecular vibration frequency of the sample during the CARS observation.

### Fifth Embodiment

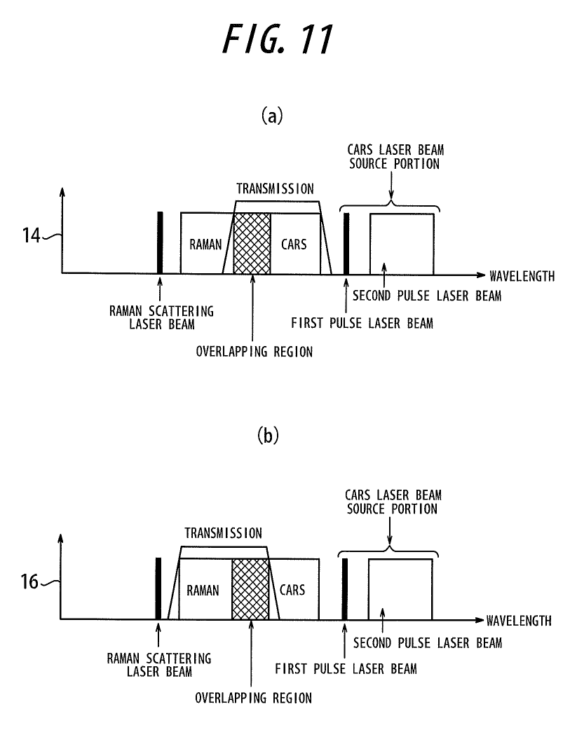

Next, a fifth embodiment of the present invention is described. This embodiment assumes a case where, as illustrated in FIG. 10, the wavelengths of the Raman scattering light and the CARS light to be observed overlap each other. Specifically, a laser microscope of this embodiment is adapted to change the wavelength of a laser beam to be emitted from the second pulse laser source 1b of FIG. 2 in accordance with the molecular vibration of the sample, and hence, depending on the molecular frequency to be observed, the CARS light may overlap with the Raman spectrum obtained from Raman scattering. In such a case, if the wavelength characteristics of the band-pass filters 14, 16 are specified as illustrated in FIGS. 11(a) and 11(b), for example, the CARS light and the Raman scattering light cannot be separated completely from each other. This embodiment provides a laser microscope that is capable of completely separating the CARS light and the Raman scattering light from each other even in such a case.

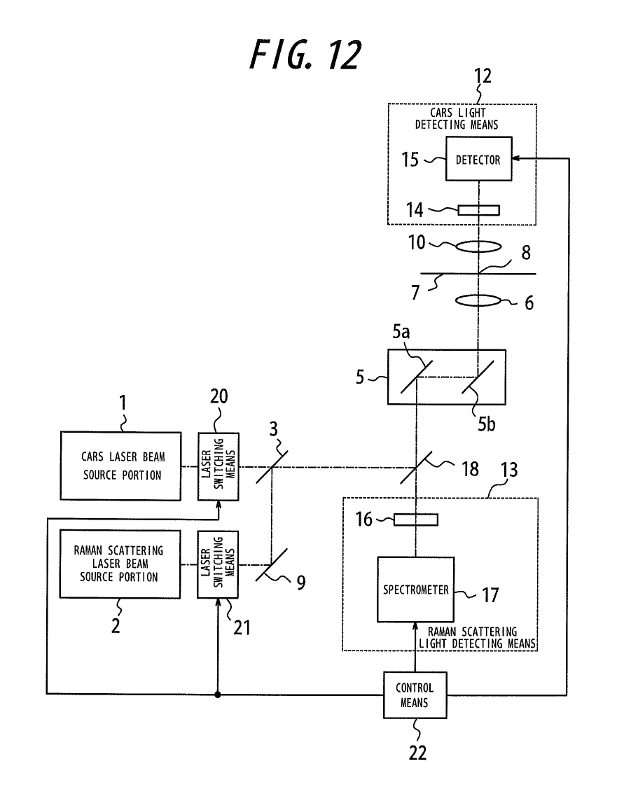

FIG. 12 is a view illustrating a schematic configuration of the laser microscope according to the fifth embodiment of the present invention. This embodiment is different from the above-mentioned third embodiment in that the CARS laser beam and the Raman scattering laser beam are configured to be switched therebetween so as to enter the sample, and the detection of the CARS light by the detector 15 and the detection of the Raman scattering light by the spectrometer 17 are controlled in synchronous with the switching between the CARS laser beam and the Raman scattering laser beam.

Specifically, in addition to the configuration of the third embodiment illustrated in FIG. 7, laser switching means 20, 21 are each disposed between the CARS laser beam source portion 1 and the half-silvered mirror 3 and between the Raman scattering laser beam source portion 2 and the reflection mirror 9, respectively, so that transmission and shielding of the laser beam can be controlled by control means 22. Further, the control means 22 also controls the start and stop of the detection function of the detector 15 and the spectrometer 17. The rest of the configuration is similar to that of the first embodiment, and hence the same constituent elements are denoted by the same reference symbols and the description thereof is omitted.

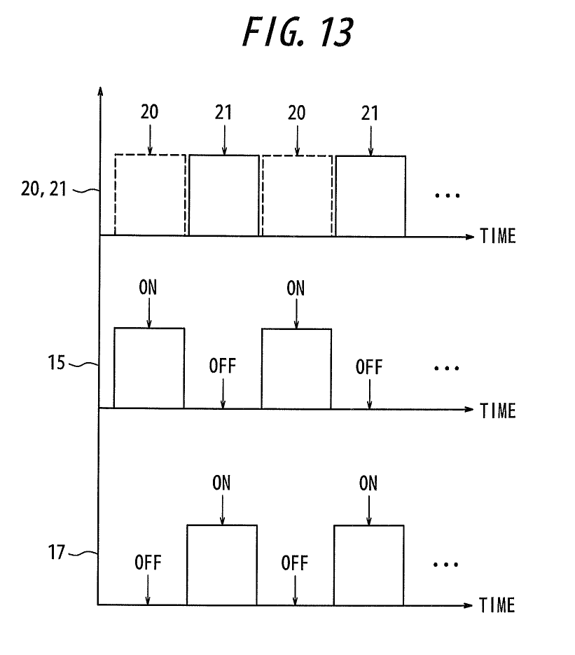

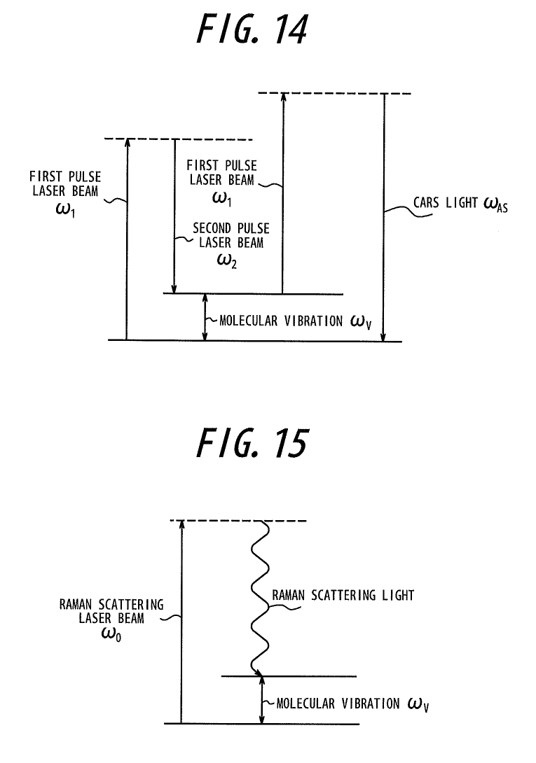

Next, the operation of this embodiment is described with reference to the time chart illustrated in FIG. 13. In this embodiment, the control means 22 alternately switches between the laser switching means 20, 21 so that the CARS laser beam and the Raman scattering laser beam can be alternately emitted without temporally overlapping each other. These laser beams each follow the optical paths described in the third embodiment so as to be focused by the lens 6 onto the sample surface 7, and the galvano-scanner 5 two-dimensionally scans the focus position on the sample surface 7.

When the CARS laser beam is being emitted, the CARS light scattering on the transmission side of the sample surface 7 is caused to enter the detector 15 for detection, similarly to the third embodiment. On the other hand, scattered light scattering on the reflection side passes through the lens 6, the galvano-scanner 5, the dichroic mirror 18, and the band-pass filter 16 so as to enter the spectrometer 17. In this state, however, the detection by the spectrometer 17 is suspended by the control means 22, and hence the CARS light is not detected.

On the other hand, when the Raman scattering laser beam is being emitted, the Raman scattering light scattering on the transmission side of the sample surface 7 passes through the lens 10 and the band-pass filter 14 so as to enter the detector 15. In this state, however, the detection by the detector 15 is suspended by the control means 22, and hence the Raman scattering light is not detected. On the contrary, the Raman scattering light scattering on the reflection side passes through the lens 6, the galvano-scanner 5, the dichroic mirror 18, and the band-pass filter 16 so as to enter the spectrometer 17 to be detected.

In this embodiment, with the above-mentioned operational method, the CARS light detection and the Raman scattering light detection are temporally separated from each other, and hence, even when the wavelengths of the Raman scattering light and the CARS light overlap each other, the CARS microscope observation and the Raman scattering light observation can be performed without the Raman scattering light and the CARS light affecting each other.

It should be noted that the present invention is not limited to the above-mentioned embodiments, and can be subjected to various alterations and modifications. For example, in the CARS laser beam source portion, the first pulse laser, as well as the second pulse laser, may also be configured as a variable-wavelength laser. Further, the CARS laser beam source portion does not necessarily employ two lasers. The CARS laser beam source portion may employ a single laser as a laser source, and the laser beam may be split into two beams using a beam splitter or the like so that one of the beams may be subjected to wavelength conversion, to thereby obtain two laser beams that are different from each other in wavelength. Still further, the scattering excitation laser sources may not necessarily be provided inside the laser microscope main body, and may also be provided separately from the main body so that the laser beams are introduced therefrom.

1. A laser microscope, comprising:
a laser irradiation optical system capable of coaxially irradiating a sample with a CARS laser beam and a Raman scattering laser beam;
CARS light detecting means for detecting CARS light generated from the sample irradiated with the CARS laser beam; and
Raman scattering light detecting means for detecting Raman scattering light generated from the sample irradiated with the Raman scattering laser beam.

2. The laser microscope according to claim 1, wherein the CARS light detecting means and the Raman scattering light detecting means are disposed on a transmission side of incident light from the laser irradiation optical system, with respect to the sample.

3. The laser microscope according to claim 2, further comprising a dichroic mirror for separating the CARS light and the Raman scattering light from each other and guiding the CARS light to the CARS light detecting means while guiding the Raman scattering light to the Raman scattering light detecting means, the dichroic mirror being disposed on the transmission side of the sample.

4. The laser microscope according to claim 1,
wherein the CARS light detecting means is disposed on a reflection side of incident light from the laser irradiation optical system, with respect to the sample; and
wherein the Raman scattering light detecting means is disposed on a transmission side of the incident light from the laser irradiation optical system, with respect to the sample.

5. The laser microscope according to claim 4, further comprising a dichroic mirror for separating the CARS laser beam and the Raman scattering laser beam from the CARS light and guiding the CARS laser beam and the Raman scattering laser beam to the sample while guiding the CARS light to the CARS light detecting means.

6. The laser microscope according to claim 1,
wherein the CARS light detecting means is disposed on a transmission side of incident light from the laser irradiation optical system, with respect to the sample; and
wherein the Raman scattering light detecting means is disposed on a refection side of the incident light from the laser irradiation optical system, with respect to the sample.

7. The laser microscope according to claim 6, further comprising a dichroic mirror for separating the CARS laser beam and the Raman scattering laser beam from the Raman scattering light and guiding the CARS laser beam and the Raman scattering laser beam to the sample while guiding the Raman scattering light to the Raman scattering light detecting means, the dichroic mirror being arranged on the reflection side of the sample.

8. The laser microscope according to claim 1,
wherein the CARS light detecting means and the Raman scattering light detecting means are disposed on a reflection side of incident light from the laser irradiation optical system, with respect to the sample.

9. The laser microscope according to claim 8, further comprising a dichroic mirror for separating the CARS light and the Raman scattering light from each other and guiding the CARS light to the CARS light detecting means while guiding the Raman scattering light to the Raman scattering light detecting means, the dichroic mirror being arranged on the reflection side of the sample.

10. The laser microscope according to any one of claims 1 to 9, wherein the CARS light detecting means has a band-pass filter for extracting only the CARS light.

11. The laser microscope according to any one of claims 1 to 10, wherein the Raman scattering light detecting means has a band-pass filter for extracting only the Raman scattering light.

12. The laser microscope according to any one of claims 1 to 11, wherein the Raman scattering light detecting means has a spectrometer for detecting a spectrum of the Raman scattering light.

13. The laser microscope according to any one of claims 1 to 12, further comprising:
switching means for switching between the CARS laser beam and the Raman scattering laser beam entering the laser irradiation optical system; and
control means for controlling the switching operation performed by the switching means.
